(19) United States
(12) Patent Application Publication
(10) Pub. No.: US 2020/0004529 A1
(43) Pub. Date: Jan. 2, 2020

(54) SYSTEMS, METHODS, AND APPARATUS FOR AUTOMATING SOFTWARE DEVELOPMENT STEPS

(71) Applicant: Betsol LLC, Broomfield, CO (US)

(72) Inventors: Chandra Ravipati, Irving, TX (US); Sandeep Kunichi, Tempe, AZ (US)

(21) Appl. No.: 16/459,215

(22) Filed: Jul. 1, 2019

Related U.S. Application Data
(60) Provisional application No. 62/692,023, filed on Jun. 29, 2018.

(51) Int. Cl. G06F 8/71; G06F 11/36; G06F 8/60; G06F 16/27; H04L 29/08; H04L 12/24

(52) U.S. Cl. CPC G06F 8/71; G06F 11/3688; G06F 8/60; G06F 16/27; G06F 8/41; H04L 41/0816; H04L 41/085; H04L 41/0876; H04L 67/34; H04L 67/10

(57) ABSTRACT

Systems, methods, and storage media for automatically managing an on-demand cloud computing platform are disclosed. Exemplary implementations may: modify an issue in a computing device issue tracking system; change the status of the issue in the computing device issue tracking system from a first status to a second status; automatically provide the configuration data to the on-demand cloud computing platform; automatically use the configuration data to modify the on-demand cloud computing platform; and automatically change the status of the issue in the computing device issue tracking system from the second status to a third status.

### CLAIM OF PRIORITY UNDER 35 U.S.C. §119

The present Application for Patent claims priority to Provisional Application No. 62/692,023, entitled Systems, Methods, and Apparatus for the Intelligent Orchestration of Automated Tools, file Jun. 29, 2019, and expressly incorporated herein by reference in its entirety.

### FIELD OF THE DISCLOSURE

The present disclosure relates to systems, methods, and storage media for automatically managing on-demand cloud computing and on-premise platforms.

### BACKGROUND

During the lifecycle of software application development, a software development team typically undertakes many manual and repetitive tasks. These tasks may delay the delivery of the application, increase costs, and can even create a decrease in the quality of various aspects of the application.

### SUMMARY

In order to prevent a delay in application delivery, decreases costs, and increase quality, an automation system, method and storage media was created. One aspect of the present disclosure relates to a system configured for automatically managing an on-demand cloud computing platform. The system may include one or more hardware processors configured by machine-readable instructions. Together with the machine-readable instructions, the processor(s) may be configured to modify an issue in a computing device issue tracking system. The issue may be related to on-demand cloud computing platform configuration data and comprise a status. The processor(s) and instructions may be configured to change the status of the issue in the computing device issue tracking system from one status to another status. The processor(s) and instructions may also be configured to automatically provide the configuration data to the on-demand cloud computing platform and instruct the on-demand cloud computing platform to automatically use the configuration data. The processor(s) and instructions may be configured to automatically change the status of the issue in the computing device issue tracking system from the second status to a third status.

Another aspect of the present disclosure relates to a method for automatically managing an on-demand cloud computing platform. The method may include modifying an issue in a computing device issue tracking system. The issue may be related to on-demand cloud computing platform configuration data and comprise a status. The method may include changing the status of the issue in the computing device issue tracking system from one status to another status. The method may include automatically providing the configuration data to the on-demand cloud computing platform. The method may include automatically using the configuration data to modify the on-demand cloud computing platform. The method may include automatically changing the status of the issue in the computing device issue tracking system from a second status to a third status.

Yet another aspect of the present disclosure relates to a non-transient computer-readable storage medium having instructions embodied thereon, the instructions being executable by one or more processors to perform a method for automatically managing an on-demand cloud computing platform. The method may include modifying an issue in a computing device issue tracking system. The issue may include on-demand cloud computing platform configuration data and a status. The method may include changing the status of the issue in the computing device issue tracking system from a first status to a second status. The method may include automatically providing the configuration data to the on-demand cloud computing platform. The method may include automatically using the configuration data to modify the on-demand cloud computing platform. The method may include automatically changing the status of the issue in the computing device issue tracking system from the second status to a third status.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for automatically managing an on-demand cloud computing platform, in accordance with one or more implementations.

FIG. 2 illustrates a method for automatically managing an on-demand cloud computing platform, in accordance with one or more implementations.

FIG. 3 illustrates an issue tracking system user interface in accordance with one or more implementations.

FIG. 4 illustrates a process flow for automatically managing an on-demand cloud computing platform, in accordance with one or more implementations.

FIG. 5 illustrates a process flow for automatically managing a code-deploy-test software development scenario in accordance with one or more implementations.

FIG. 6 illustrates a graphical representation of code-deploy-test automation system architecture in accordance with one or more implementations.

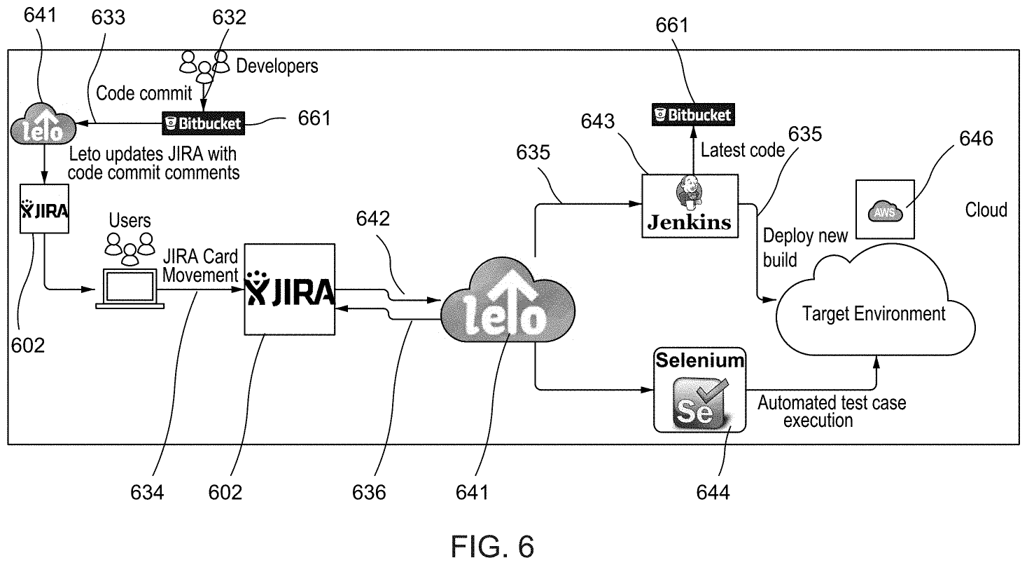

FIG. 7 illustrates a graphical representation of an automation system architecture for managing an on-demand cloud computing platform, in accordance with one or more implementations.

FIG. 8 illustrates a graphical representation of a code-deploy-test automation system architecture for data extraction, ETL, and data ingestion applications in accordance with one or more implementations.

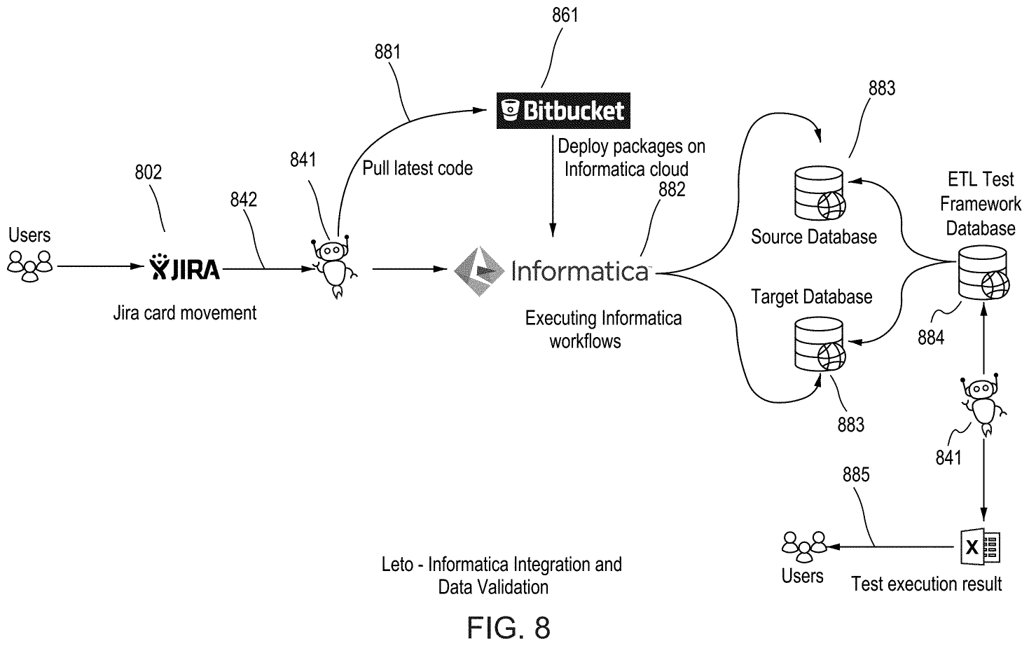

FIG. 9 illustrates a graphical representation of an ETL/Big Data Test automation system architecture in accordance with one or more implementations.

FIG. 10 illustrates a graphical representation of a performance testing automation system architecture in accordance with one or more implementations.

FIG. 11 illustrates a process flow for automatically provisioning users with an automation system in accordance with one or more implementations.

FIG. 12 illustrates a graphical representation of a micro service management automation system architecture in accordance with one or more implementations.

### DETAILED DESCRIPTION

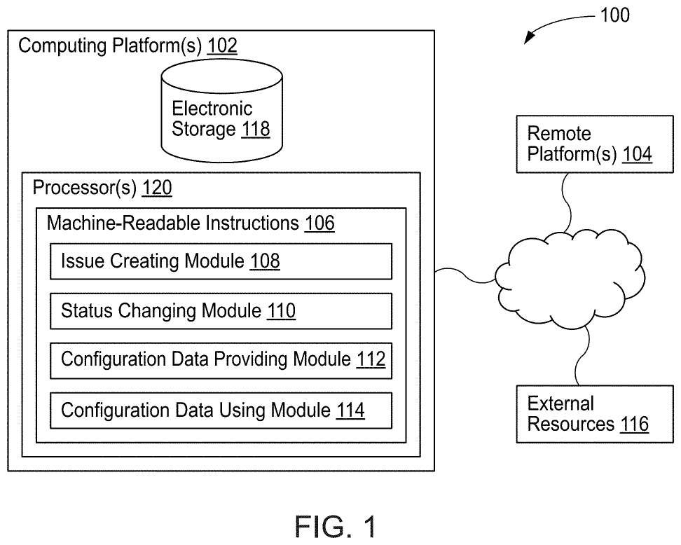

FIG. 1 illustrates an automation system 100 configured for automatically managing an on-demand cloud computing platform, in accordance with one or more implementations. The automation system 100 may also be referred to as a system 100. In some implementations, the system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of issue modifying module 108, status changing module 110, configuration data providing module 112, configuration data using module 114, and/or other instruction modules.

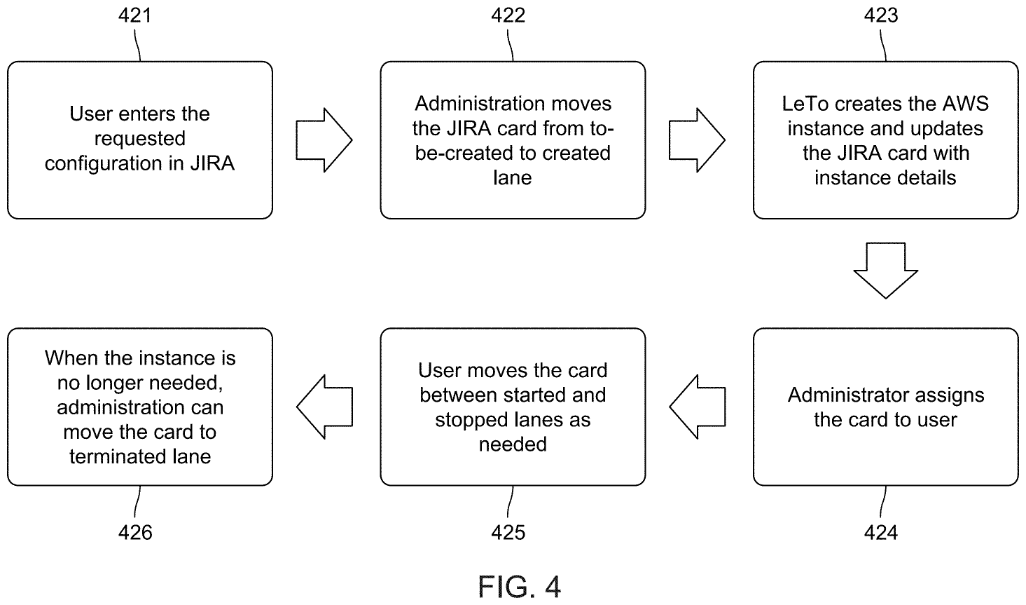

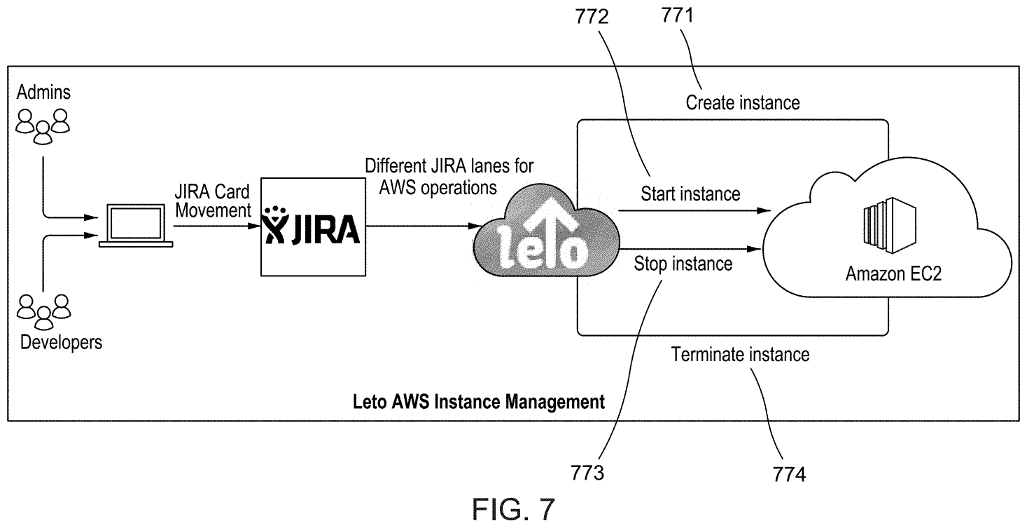

Issue modifying module 108 may be configured to modify an issue in a computing device issue tracking system. As seen in FIG. 4, modifying an issue in a computing device issue tracking system may comprise the step 421 of a user entering a requested computing device configuration in the issue tracking system. One computing device issue tracking system comprises the Jira software system provided by Atlassian, located at Level 6, 341 George Street Sydney, NSW, 2000, Australia. The requested configuration may comprise on-demand cloud computing platform configuration data. In addition to the configuration data, the issue may further comprise an issue status. One on-demand cloud computing platform comprises the Amazon Web Services (“AWS”) platform provided by Amazon Web Services Inc., located at 410 Terry Avenue North, Seattle, Wash., 98109. By way of a non-limiting example, the on-demand cloud computing platform configuration data may include data related to one or more of creating 771, starting 772, stopping 773, and terminating 774 a virtual server instance for running one or more applications, as seen in FIG. 7. One virtual server instance may comprise a virtual server in Amazon's Elastic Compute Cloud (“EC2”). The virtual server instance may also include a distributed relational database web service such as, but not limited to an Amazon Relational Database Service (“RDS”) instance. The on-demand cloud computing platform configuration data may further comprise data related to managing user identities and permissions associated with the on-demand cloud computing platform. One such user identities and permission may comprise AWS Identity and Access Management (“TAM”) user identities and permissions. The on-demand cloud computing platform configuration data may further comprise data to create and manage virtual private cloud (“VPC”) resources such as, but not limited to, an Amazon VPC network within the infrastructure of AWS.

The on-demand cloud computing platform configuration data may also comprise data related to configuring security groups and network access control lists for virtual private clouds. One such security group may comprise a virtual firewall for an EC2 instance to control inbound and outbound traffic. One such network access control list may comprise rules that also act as a firewall for controlling traffic in and out of one or more VPC subnets. The on-demand cloud computing platform configuration data may also comprise data related to maintaining container orchestration. For example, container orchestration may relate to an Amazon Elastic Container Service (“ECS”) that enables software application communication with Docker containers on AWS. Docker containers comprise software provided by Docker, Inc., located at 144 Townsend Street, San Francisco, Calif., 94107.

On-demand cloud computing platform configuration data may include data related to configuring object data storage architectures and buckets. One such object data storage may comprise the Amazon Simple Storage Service (“S3”). One bucket may comprise a public cloud resource such as, but not limited to file folders or similar objects, in the Amazon S3 adapted to store data and descriptive metadata. On-demand cloud computing platform configuration data may comprise data related to using a monitoring and management service to track and manage one or more virtual server instances. One such monitoring and management service may comprise the Amazon CloudWatch monitoring service for AWS cloud resources and software applications run on AWS. Configuration data may be related to managing and modifying the collection and tracking of metrics, collecting and monitoring log files, setting alarms, and automatically reacting to changes in AWS cloud resources. Such a service may be used to monitor EC2 and RDS instances. It is further contemplated that the on-demand cloud computing platform configuration data may comprise data related to using a domain name system service for routing internet traffic. One such domain name system (DNS) service may comprise the Amazon Route 53 DNS web service, which may be used to connect user requests to infrastructure running in AWS and infrastructure outside of AWS. The on-demand cloud computing platform configuration data may comprise configuration data for a message delivery notification service. One such notification service may comprise the Amazon Simple Notification Service (“SNS”) and messages may comprise end user notifications comprising mobile push, short message service (i.e., SMS/text), and email.

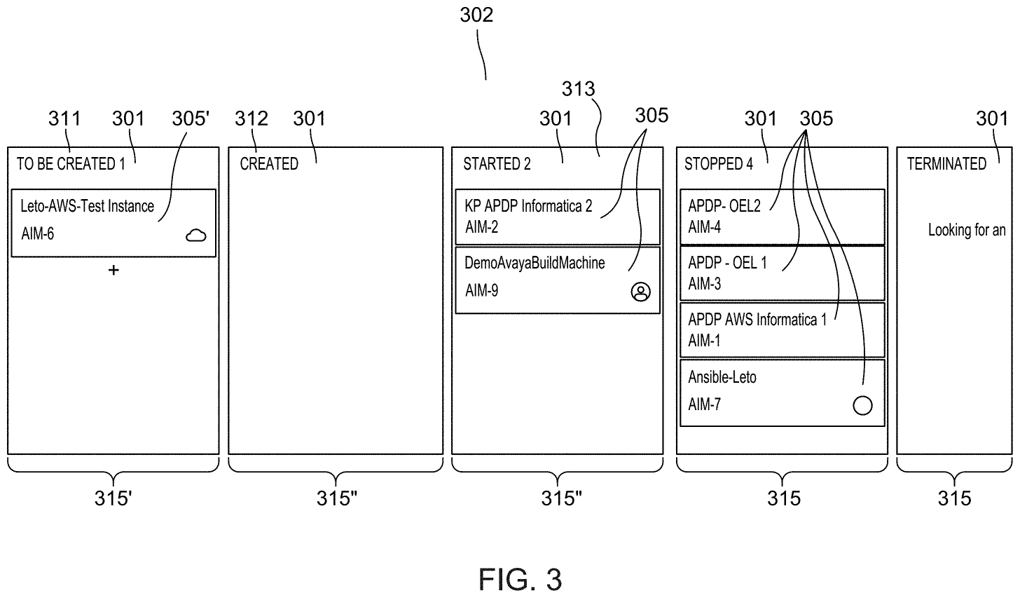

Seen in FIG. 3 is one example of a user interface in an issue tracking system 302. Such a user interface may be accessed via a web browser software application such as, but not limited to Internet Explorer. Seen in the issue tracking system 302 are various issues 305 with a status 301 assigned to each issue 305. One such issue 305 may comprise a JIRA card and each status 301 may comprise a column 315. Changing the status 301 of an issue 305 in the computing device issue tracking system 302 from a first status to a second status may include selecting an issue 305′ and moving the issue 305′ from the first column 315′ to the second column 315″ via, for example, a select-and-drag method with a hand-held computer pointing device, i.e. a computer mouse. Although the first column 315′ is associated with the “to be created” status 311 and the second column 315″ is associated with the “created” status 312, it is contemplated that any of the status seen in FIG. 3 may comprise a first status and a second status. Changing the status of the issue may invoke an automation system with a webhook. One such automation system may comprise the automation system described herein. A webhook may also be referred to as an HTTP push API. Creating an issue 305 in a computing device issue tracking system 302 and changing the status 301 of the issue in the computing device issue tracking system 302 from a first status 311 to a second status 312 may include manually creating a new issue 310 in a computing device issue tracking system at the to be created column 315 and manually changing the status of the issue in the computing device issue tracking system from the to-be-created column 315′ a created column 315″.

Status changing module 110 may be configured to change the status of the issue 305 in the computing device issue tracking system 302 from a first status to a second status. For example, as seen at step 422 in FIG. 4, changing the status may comprise moving a JIRA card from the to-be-created to a created column previously described. Status changing module 110 may be further configured to automatically change the status of the issue 305 in the computing device issue tracking system from the second status to a third status such as, but not limited to, the started status 313. Automatically changing the status of the issue 305 in the computing device issue tracking system 302 from the second status 312 to a third status 313 may comprise using the automation system to access the computing device issue tracking system 302 and provide the system with the necessary information to change the status from the second status to a third status without additional user input after a specific action occurs. For example, the configuration data associated with the issue 305 may be provided to the on-demand cloud computing platform from the automation system and the configuration data may be used by the on-demand cloud computing platform to modify the on-demand cloud computing platform. The automation system may be informed that the configuration data was accurately used and then the automation system may move the issue from one column 315″ to another column 315′″. As seen at step 423 of FIG. 4, the automation system (“LeTo”) may use the configuration data to automatically crate an AWS instance and update the JIRA card with instance details.

In one embodiment, configuration data providing module 112 may automatically provide the configuration data to the on-demand cloud computing platform and configuration data using module 114 may be configured to automatically use the configuration data to modify the on-demand cloud computing platform. In some implementations, a single module may automatically provide the configuration data to the on-demand cloud computing platform and use the configuration data to modify the on-demand cloud computing platform. As seen at steps 424, 425 and 426 of FIG. 4, one process may further comprise assigning a card to a user, moving the card between columns and moving the card to a terminated column, respectively.

In some implementations, server(s) 102, client computing platform(s) 104, and/or external resources 116 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 116 may be operatively linked via some other communication media.

One client computing platform 104 may include one or more processors configured to execute computer program modules. The computer program modules may be configured to enable an expert or user associated with the given client computing platform 104 to interface with system 100 and/or external resources 116, and/or provide other functionality attributed herein to client computing platform(s) 104. By way of non-limiting example, the given client computing platform 104 may include one or more of a server, a desktop computer, a laptop computer, a handheld computer, a tablet computing platform, a NetBook, a Smartphone, a gaming console, and/or other computing platforms.

External resources 116 may include sources of information outside of system 100, external entities participating with system 100, and/or other resources. In some implementations, some or all of the functionality attributed herein to external resources 116 may be provided by resources included in system 100.

Server(s) 102 may include electronic storage 118, one or more processors 120, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may comprise non-transitory storage media that electronically stores information. The electronic storage media of electronic storage 118 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor(s) 120, information received from server(s) 102, information received from client computing platform(s) 104, and/or other information that enables server(s) 102 to function as described herein.

Processor(s) 120 may be configured to provide information processing capabilities in server(s) 102. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 1 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. Processor(s) 120 may be configured to execute modules 108, 110, 112, and/or 114, and/or other modules. Processor(s) 120 may be configured to execute modules 108, 110, 112, and/or 114, and/or other modules by software; hardware; firmware; some combination of software, hardware, and/or firmware; and/or other mechanisms for configuring processing capabilities on processor(s) 120. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, and/or 114 are illustrated in FIG. 1 as being implemented within a single processing unit, in implementations in which processor(s) 120 includes multiple processing units, one or more of modules 108, 110, 112, and/or 114 may be implemented remotely from the other modules. The description of the functionality provided by the different modules 108, 110, 112, and/or 114 described below is for illustrative purposes, and is not intended to be limiting, as any of modules 108, 110, 112, and/or 114 may provide more or less functionality than is described. For example, one or more of modules 108, 110, 112, and/or 114 may be eliminated, and some or all of its functionality may be provided by other ones of modules 108, 110, 112, and/or 114. As another example, processor(s) 120 may be configured to execute one or more additional modules that may perform some or all of the functionality attributed below to one of modules 108, 110, 112, and/or 114. Furthermore, any functionality described herein may comprise a portion of any of modules 108, 110, 112, and/or 114 or may comprise at least a portion of any additional module.

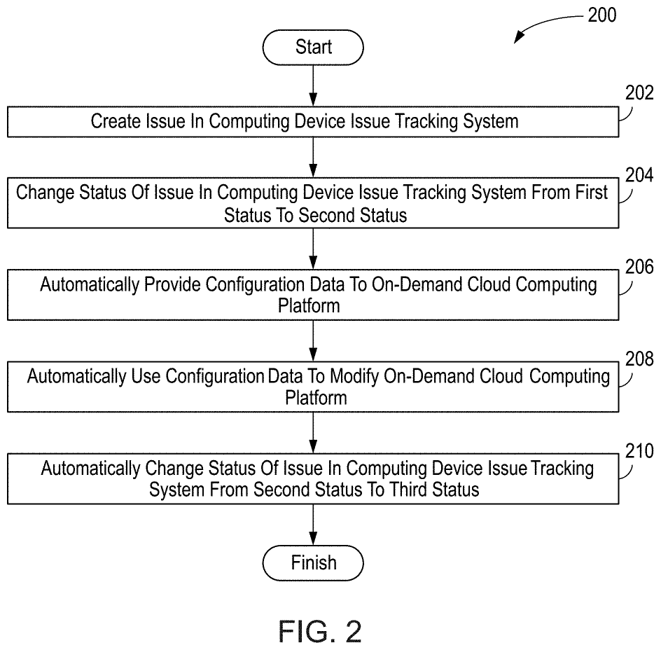

FIG. 2 illustrates a method 200 for automatically managing an on-demand cloud computing platform, in accordance with one or more implementations. The operations of method 200 presented below are intended to be illustrative. In some implementations, method 200 may be accomplished with one or more additional operations described herein, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

A first operation 202 in method 200 may comprise creating the issue 305 in a computing device issue tracking system 302. The issue 305 may include on-demand cloud computing platform configuration data, as described herein, and may be associated with a status 301. The first operation 202 may be performed by one or more hardware processors configured by machine-readable instructions including a module that is the same as or similar to issue creating module 108, in accordance with one or more implementations.

A next operation 204 may include changing the status 301 of the issue in the computing device issue tracking system from a first status 311 to a second status 312. Operation 204 may be performed by one or more hardware processors configured by machine-readable instructions including a module that is the same as or similar to status changing module 110, in accordance with one or more implementations.

Another operation 206 may include automatically providing the configuration data to the on-demand cloud computing platform. Operation 206 may be performed by one or more hardware processors configured by machine-readable instructions including a module that is the same as or similar to configuration data providing module 112, in accordance with one or more implementations.

Operation 208 may include automatically using the configuration data to modify the on-demand cloud computing platform. Operation 208 may be performed by one or more hardware processors configured by machine-readable instructions including a module that is the same as or similar to configuration data using module 114, in accordance with one or more implementations.

An operation 210 may include automatically changing the status 301 of the issue 305 in the computing device issue tracking system 302 from the second status 312 to a third status 313. Operation 210 may be performed by one or more hardware processors configured by machine-readable instructions including a module that is the same as or similar to status changing module 110, in accordance with one or more implementations.

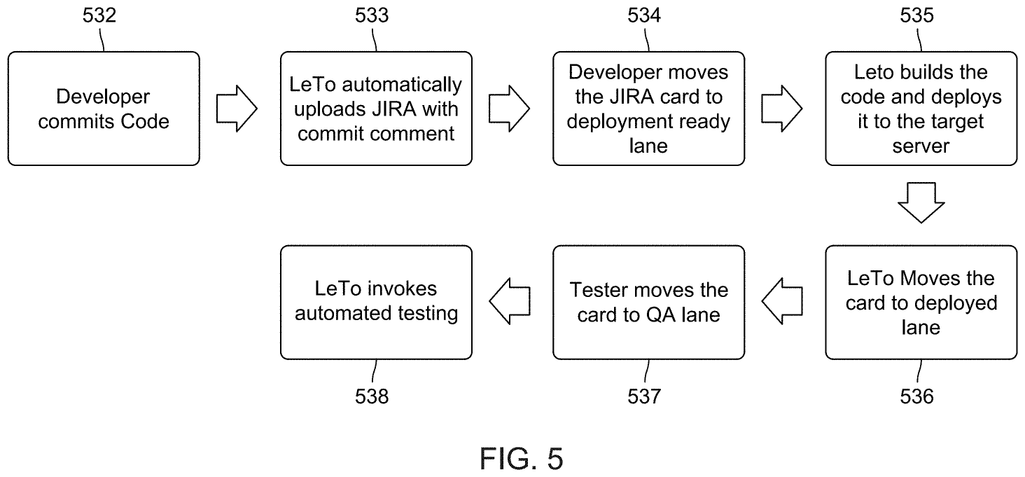

Turning now to FIGS. 5 & 6, seen is a method 531, 631 of automating the deployment and testing of software applications. At step 532, 632 the method 531, 631 comprises committing code to a source code repository 661. One such source code repository may comprise Bitbucket, a web-based version control repository hosting service provided by Atlassian, located at Level 6, 341 George Street Sydney, NSW, 2000, Australia. Step 533, 633 may comprise either automatically updating an already-created issue 305 or automatically creating a new issue 305 in a computing device issue tracking system 302. For example, upon committing code to a source code repository, a communication may be issued to an automation system 641 from the repository 661 that instructs the automation system 641 to automatically update an already-created issue or automatically create a new issue in a computing device issue tracking system 302, 602. Step 533, 633 further comprises using the issue in the issue tracking system 602 to identify that code has been committed to the source code repository. Using the issue in the issue tracking system to identify that code has been committed to the source code repository may comprise using the automation system 641 to automatically update the issue tracking system 602 with code commit comments. Step 534, 634 comprises changing the status of the issue in the computing device issue tracking system from a first status to a second status. Changing the status of the issue in the computing device issue tracking system from a first status to a second status may comprise manually or automatically changing the status of the issue in the computing device issue tracking system from a To-Do column to one of an In-Progress column and a Deployment-Ready column. Additionally, changing the status of the issue in the computing device issue tracking system from a first status to a second status may comprise utilizing a web browser software application to change the status of the issue and may further comprise activating an automation system 641 with a webhook 642.

Step 535, 635 comprises automatically building the code and deploying the code to a target server while step 536, 636 comprises changing the status of the issue in the computing device issue tracking system 602 from the second status to a third status. As described herein, the target server may comprise a virtual server instance. Also, changing the status of the issue in the computing device issue tracking system 602 from the second status to a third status may comprise automatically changing the status of the issue in the computing device issue tracking system 602 from one of an In-Progress column and the Development-Ready column to one of a Deployed column and a Deployment-Done column. The automation system 641 may be used to automatically build the code, deploy the code to a target server, and change the status of the issue in the computing device issue tracking system from the second status to a third status. Step 537 comprises changing the status of the issue in the computing device issue tracking system 302 from the third status to a fourth status and step 538 comprises automatically testing the code. Changing the status of the issue in the computing device issue tracking system from the third status to a fourth status may comprise manually or automatically_changing the status of the issue in the computing device issue tracking system from one of the Deployed column and the Deployment-Done column to one of a QA testing column and a QA column. Automatically testing the code may comprise using the automation system 641 to communicate with at least one of an open source automation server 643 to test the code and a framework 644 for testing web applications to automate text case execution. It is contemplated that the open source automation server may communicate directly with the source code repository 661. One such open source automation server 643 comprises Jenkins, created by Kohskue Kwaguchi and released under the MIT License, a permissive free software license originating at the Massachusetts Institute of Technology (“MIT”), located at 77 Massachusetts Avenue, Cambridge, Mass., 02139. One such framework 644 comprises Selenium, an open-source software released under the Apache 2.0 license by the Apache Software Foundation located at 401 Edgewater Place, Suite 200, Wakefield, Mass. 01880. In one embodiment, after testing the code, the automation system 641 deploys 635 a new code build to the target server such as but limited to, an on-demand cloud computing platform 646.

In one embodiment, changing the status of the issue 305 in the computing device issue tracking system 302 from a first status 311 to a second status 312 comprises utilizing a web browser software application to change the status of the issue 305 and upon doing so, having the issue tracking system 302, 802 activate an automation system with a webhook 842. It is contemplated that automatically building the code and deploying the code to a target server comprises using the automation system to instruct a web-based version control repository hosting service 861 to pull 881 a latest code version from the service 861, deploy 835 code packages to an enterprise cloud data management and data integration system 882, and execute workflows associated with the enterprise cloud data management and data integration system 882. Such workflows comprise automatically testing the code by (i) managing communications between (a) the enterprise cloud data management and data integration system 882 and one or more source and target databases 883 and (b) the one or more source and target databases 883 and an extract, transform, and load testing framework 884 and (ii) communicating between the automation system 841 and the extract, transform, and load testing framework 884, and providing 885 test execution results to one or more users.

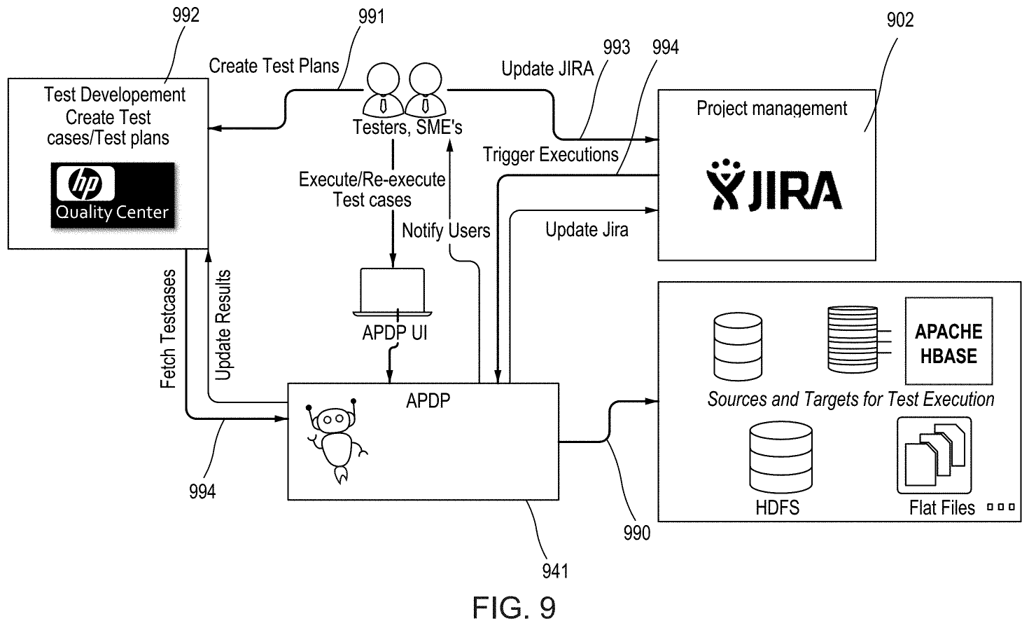

As seen in FIG. 9, one embodiment of the invention may comprise creating and uploading 991 a test plan to a software quality assurance test management system 992 after committing code to a source code repository. Upon changing the status 993 of the issue in the computing device issue tracking system 902 from a first status to a second status, the system 902 may trigger 994 the automation system 941 to fetch 995 the test cases from the software quality assurance test management system 992 and automatically test the code by utilizing a load testing tool for analyzing and measuring the performance of one or more web applications, and applying 990 SQL commands to one or more databases. It is contemplated that the one or more databases comprise at least one of a SQL server, an enterprise application software system, a distributed file system, a flat-file database; and an open-source, distributed, versioned, non-relational database and the SQL commands may be used to automatically obtain test results and manually compare the test results.

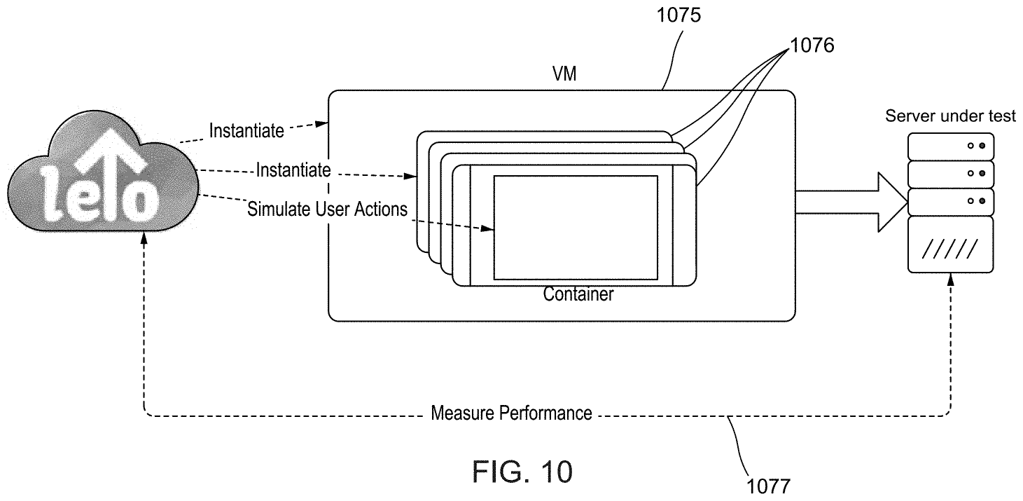

As seen in FIG. 10 it is contemplated that the automation system 1002 may comprise a load testing tool for analyzing and measuring the performance of one or more web applications by instantiating a virtual machine 1075, instantiating one or more containers 1076, simulating user actions in the one or more containers, and measuring performance of the one more web applications by combining 1077 one or more test reports into a single modified test report.

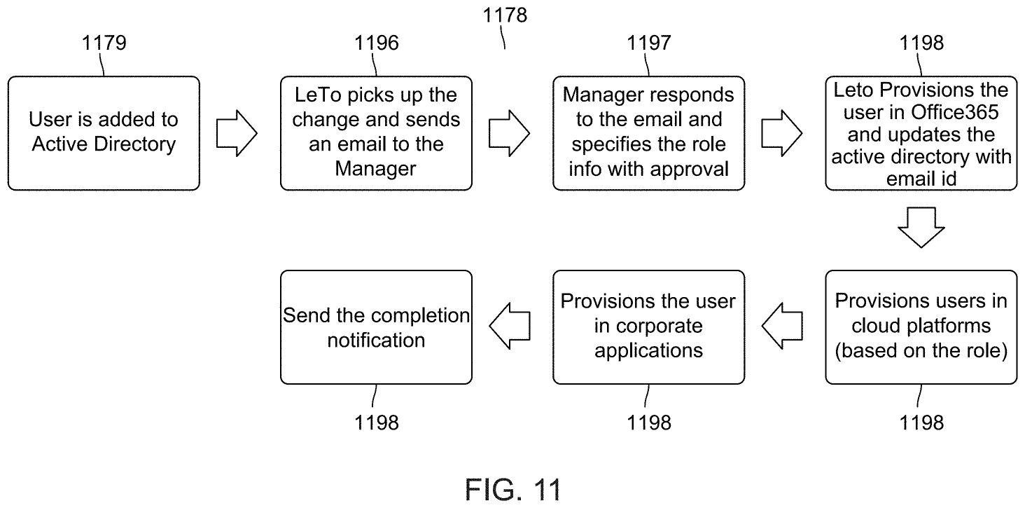

Turning now to FIG. 11, seen is a method 1178 of automatically provisioning user accounts. At step 1179 one such method 1178 comprises modifying a user account in a directory service. Modifying a user account comprises one of adding a user account, temporarily deactivating a user account, reactivating a user account, and terminating a user account. At step 1196 the method 1178 comprises notifying an automation system of the user account modification and sending a notification of the user account modification from the automation system to a directory service administrator. It is contemplated that sending a notification of the user account modification from the automation system to a directory service administrator comprises at least one of emailing the administrator, using a collaboration software tool to contact the administrator, providing a digital message to an administrator mobile device, and provide an audio message to the administrator. One such collaboration software tool may comprise Slack, provided by Slack Technologies, Inc., located at 500 Howard St., San Francisco, Calif., 94105.

At step 1197 the method 1178 comprises sending a response from the directory service administrator to the automation system, wherein the response comprises approving a role for the user. At step 1198 the method comprises receiving the response at the automation system and using the automation system to (a) provision the user's access to one or more subscription software applications, one or more cloud platforms, and/or one or more corporate software applications, (b) update the directory service with an email address, and (c) provide a completion notification to the directory service administrator.

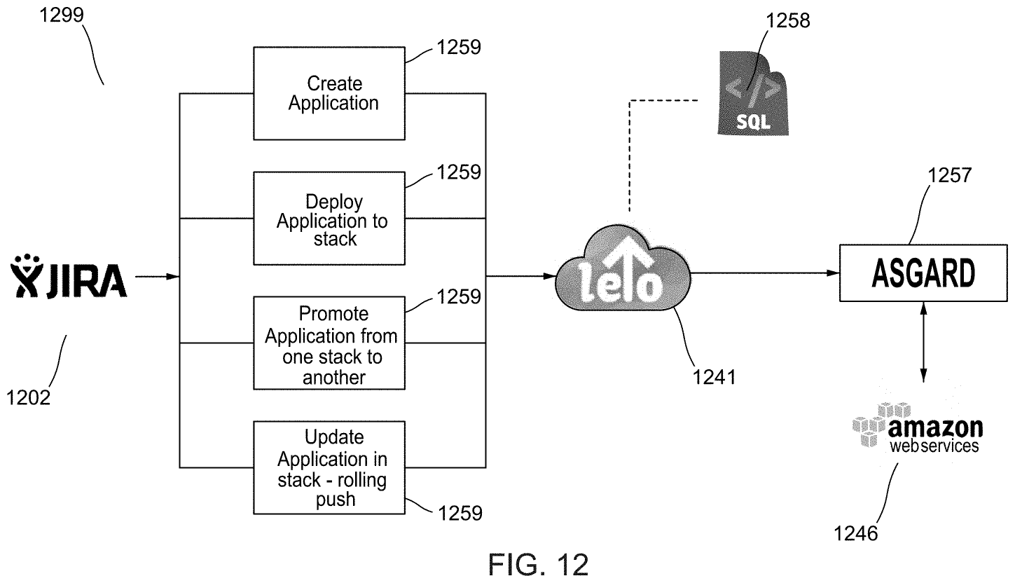

Turning now to FIG. 12, seen is a method 1299 of automatically managing micro service software application development. One such method comprises creating a new issue in a computing device issue tracking system 1202. It is contemplated that the new issue comprises a status and is related to software application configuration data 1259 within a source code repository. Upon changing the status of the issue in the computing device issue tracking system 1202 from a first status to a second status, the automation system 1241 may access the configuration data 1259 and a relational database management system 1258, and using the software application configuration data and data received from the relational database management system 1258 with a web interface for application deployments and cloud management in Amazon Web Services (AWS) 1257 to modify the software application at a target server 1246. Upon doing so, the automation system 1241 changes the status of the issue in the computing device issue tracking system from the second status to a third status.

In such a method 1259, it is contemplated that the software application configuration data comprises data related to at least one of, creating the software application, deploying the software application to the stack, promoting the software application from one stack to another; and updating the application in the stack.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for automatically managing an on-demand cloud computing platform, the system comprising:
one or more hardware processors configured by machine-readable instructions to:
create an issue in a computing device issue tracking system, wherein the issue comprises on-demand cloud computing platform configuration data and a status;
change the status of the issue in the computing device issue tracking system from a first status to a second status;
automatically provide the configuration data to the on-demand cloud computing platform;
automatically use the configuration data to modify the on-demand cloud computing platform; and
automatically change the status of the issue in the computing device issue tracking system from the second status to a third status.

2. The system of claim 1, wherein the on-demand cloud computing platform configuration data comprises data related to perform one or more of creating, starting, stopping, and terminating a virtual server instance for running one or more applications;
wherein the on-demand cloud computing platform configuration data comprises data related to perform managing user identities and permissions on the on-demand cloud computing platform;
wherein the on-demand cloud computing platform configuration data comprises data related to perform creating and managing virtual private cloud resources;
wherein the on-demand cloud computing platform configuration data comprises data related to perform configuring security groups and network access control lists for virtual private clouds;
wherein the on-demand cloud computing platform configuration data comprises data related to perform maintaining container orchestration;
wherein the on-demand cloud computing platform configuration data comprises data related to perform configuring at least one of object data storage architectures and buckets;
wherein the on-demand cloud computing platform configuration data comprises data related to perform using a monitoring and management service to track and manage one or more virtual server instances;
wherein the on-demand cloud computing platform configuration data comprises data related to perform using a domain name system service for routing internet traffic; or wherein the on-demand cloud computing platform configuration data comprises data related to perform using a notification service for message delivery.

3. The system of claim 2, wherein the virtual server instance comprises a distributed relational database web service.

4. The system of claim 1, wherein changing the status of the issue in the computing device issue tracking system from a first status to a second status comprises utilizing a web browser software application to change the status of the issue;
wherein changing the status of the issue comprises activating an automation system with a webhook; and
wherein automatically providing the configuration data to the on-demand cloud computing platform, using the configuration data to modify the on-demand cloud computing platform, wherein the one or more hardware processors are further configured by machine-readable instructions to change the status of the issue in the computing device issue tracking system from the second status to a third status comprises using the automation system to provide the configuration data to the on-demand cloud computing platform, use the configuration data to modify the on-demand cloud computing platform, and change the status of the issue in the computing device issue tracking system from the second status to a third status without additional user input.

5. A non-transient computer-readable storage medium having instructions embodied thereon, the instructions being executable by one or more processors to perform a method for automatically managing an on-demand cloud computing platform, the method comprising:
creating an issue in a computing device issue tracking system, wherein the issue comprises on-demand cloud computing platform configuration data and a status;
changing the status of the issue in the computing device issue tracking system from a first status to a second status;
automatically providing the configuration data to the on-demand cloud computing platform;
automatically using the configuration data to modify the on-demand cloud computing platform; and
automatically changing the status of the issue in the computing device issue tracking system from the second status to a third status.

6. The computer-readable storage medium of claim 5, wherein the on-demand cloud computing platform configuration data comprises data related to perform one or more of creating, starting, stopping, and terminating a virtual server instance for running one or more applications;
wherein the on-demand cloud computing platform configuration data comprises data related to perform managing user identities and permissions on the on-demand cloud computing platform;
wherein the on-demand cloud computing platform configuration data comprises data related to perform creating and managing virtual private cloud resources;
wherein the on-demand cloud computing platform configuration data comprises data related to perform configuring security groups and network access control lists for virtual private clouds;
wherein the on-demand cloud computing platform configuration data comprises data related to perform maintaining container orchestration;
wherein the on-demand cloud computing platform configuration data comprises data related to perform configuring at least one of object data storage architectures and buckets;
wherein the on-demand cloud computing platform configuration data comprises data related to perform using a monitoring and management service to track and manage one or more virtual server instances;
wherein the on-demand cloud computing platform configuration data comprises data related to perform using a domain name system service for routing internet traffic; or
wherein the on-demand cloud computing platform configuration data comprises data related to perform using a notification service for message delivery.

7. The computer-readable storage medium of claim 6, wherein the virtual server instance comprises a distributed relational database web service.

8. The computer-readable storage medium of claim 5, wherein creating a new issue in a computing device issue tracking system and changing the status of the issue in the computing device issue tracking system from a first status to a second status comprises manually creating a new issue in a computing device issue tracking system and manually changing the status of the issue in the computing device issue tracking system from a to-be-created column a created column.

9. A method of automating the deployment and testing of software applications, automatically provisioning user accounts, and automatically managing micro service software application development comprising,
committing code to a source code repository;
one of automatically updating an already-created issue and automatically creating a new issue in a computing device issue tracking system;
using the issue in the issue tracking system to identify that code has been committed to the source code repository;
changing the status of the issue in the computing device issue tracking system from a first status to a second status;
automatically
building the code,
deploying the code to a target server, and
changing the status of the issue in the computing device issue tracking system from the second status to a third status;
changing the status of the issue in the computing device issue tracking system from the third status to a fourth status;
automatically testing the code;
modifying a user account in a directory service;
notifying an automation system of the user account modification;
sending a notification of the user account modification from the automation system to a directory service administrator;
sending a response from the directory service administrator to the automation system, wherein the response comprises approving a role for the user;
receiving the response at the automation system;
using the automation system to
provision the user's access to one or more subscription software applications, one or more cloud platforms, and one or more corporate software applications,
update the directory service with an email address, and
providing a completion notification to the directory service administrator; and
creating a new issue in a computing device issue tracking system wherein the new issue comprises
software application configuration data, and
a status;
changing the status of the issue in the computing device issue tracking system from a first status to a second status;
automatically
providing the software application configuration data to a relational database management system,
using the software application configuration data to modify the software application, and
changing the status of the issue in the computing device issue tracking system from the second status to a third status.

10. The method of claim 9 wherein,
using the issue in the issue tracking system to identify that code has been committed to the source code repository comprises uploading the issue tracking system with code commit comment;
changing the status of the issue in the computing device issue tracking system from a first status to a second status comprises one of automatically and manually changing the status of the issue in the computing device issue tracking system from a To-Do column to one of an In-Progress lane and a Deployment-Ready column;
changing the status of the issue in the computing device issue tracking system from the second status to a third status comprises automatically changing the status of the issue in the computing device issue tracking system from one of the In-Progress column and the Development-Ready column to one of a Deployed column and a Deployment-Done column; and
changing the status of the issue in the computing device issue tracking system from the third status to a fourth status comprises manually or automatically changing the status of the issue in the computing device issue tracking system from one of the Deployed column and the Deployment-Done column to one of a QA testing column and a QA column.

11. The method of claim 9 wherein, the target server comprises a virtual server instance.

12. The method of claim 9 wherein,
changing the status of the issue in the computing device issue tracking system from a first status to a second status comprises utilizing a web browser software application to change the status of the issue;
changing the status of the issue comprises activating an automation system with a webhook;
automatically building the code, deploying the code to a target server, and changing the status of the issue in the computing device issue tracking system from the second status to a third status comprises using the automation system to automatically build the code, deploy the code to a target server, and change the status of the issue in the computing device issue tracking system from the second status to a third status; and
automatically testing the code comprises using the automation system to communicate with at least one of,
an open source automation server to test the code, wherein the open source automation server communicates directly with the source code repository, and
a framework for testing web applications to automate text case execution.

13. The method of claim 9 wherein,
changing the status of the issue in the computing device issue tracking system from a first status to a second status comprises utilizing a web browser software application to change the status of the issue;
changing the status of the issue comprises activating an automation system with a webhook;
automatically building the code and deploying the code to a target server comprises using the automation system to instruct a web-based version control repository hosting service to pull a latest code version, deploy code packages to an enterprise cloud data management and data integration system, and execute workflows associated with the enterprise cloud data management and data integration system; and
automatically testing the code comprises
instructing communications between
the enterprise cloud data management and data integration system and one or more source and target databases and
the one or more source and target databases and an extract, transform, and load testing framework,
communicating with the extract, transform, and load testing framework, and
providing test execution results to one or more users.

14. The method of claim 9 further comprising,
creating and uploading a test plan to a software quality assurance test management system after committing code to a source code repository; wherein,
changing the status of the issue in the computing device issue tracking system from a first status to a second status comprises utilizing a web browser software application to change the status of the issue;
changing the status of the issue comprises activating an automation system with a webhook;
automatically testing the code comprises using the automation system to at least one of,
utilize a load testing tool for analyzing and measuring the performance of one or more web applications, and
upload requests to the test plan, fetch testcases from the software quality assurance test management system, and apply SQL commands to one or more databases.

15. The method of claim 14 wherein, the one or more databases comprises at least one of,
a SQL server;
an enterprise application software system;
a distributed file system;
a flat-file database; and
an open-source, distributed, versioned, non-relational database.

16. The method of claim 14 further comprising,
automatically obtain test results; and
automatically comparing the test results.

17. The method of claim 14 wherein, utilize a load testing tool for analyzing and measuring the performance of one or more web applications comprises,
instantiating a virtual machine;
instantiating one or more containers;
simulating user actions in the one or more containers; and
measuring performance of the one or more web applications by combining one or more test reports into a single modified test report.

18. The method of claim 17 wherein, sending a notification of the user account modification from the automation system to a directory service administrator comprises at least one of,
emailing the administrator;
using a collaboration software tool to contact the administrator;
provide a digital message to an administrator mobile device; and
provide an audio message to the administrator.

19. The method of claim 17 wherein modifying a user account comprises one of,
adding a user account;
temporarily deactivating a user account;
reactivating a user account; and
terminating a user account.

20. The method of claim 19 wherein, the software application configuration data comprises data related to at least one of,
creating the software application;
deploying the software application to the stack;
promoting the software application from one stack to another; and
updating the application in the stack.
